(19) United States
(12) Patent Application Publication
(10) Pub. No.: US 2011/0010419 A1
(43) Pub. Date: Jan. 13, 2011

(54) MOBILE TERMINAL, INFORMATION DISTRIBUTION SERVER, AND INFORMATION DISTRIBUTION SYSTEM

(75) Inventors: Naohiro NAKAMURA, Fukuoka (JP); Atsushi Tsukazoe, Fukuoka (JP); Hidehiko Satoh, Fukuoka (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/884,802

(22) Filed: Sep. 17, 2010

Related U.S. Application Data
(63) Continuation of application No. PCT/JP2008/054952, filed on Mar. 18, 2008.

(51) Int. Cl. G06F 15/16

(52) U.S. Cl. 709/203

(57) ABSTRACT

A mobile terminal includes: a notification information receiving portion for receiving notification information indicating the type of newly-stored user information or updated user information, from a user information storing portion; a type collating portion for deciding whether or not the type of the user information indicated by request type information registered in a request type recording portion and the type of the user information indicated by the notification information coincide with each other; a request information transmitting portion for, in a case where a decision of coincidence is made, transmitting, to the information delivery server, user request information to request delivery of the newly-stored user information or the updated user information to the mobile terminal; an information receiving portion for receiving user request information delivered from the information delivery server, in accordance with the transmitted user request information; and a display control portion for displaying the received user information on a predetermined display area of a display portion.

### CROSS-REFERENCE TO RELATED APPLICATIONS

This application is based upon and claims the benefit of priority of the prior Japanese Patent Application No. PCT/JP2008/054952, filed on 18 Mar. 2008, the entire contents of which are incorporated herein by reference.

### FIELD

The present invention relates to a mobile terminal having a display portion for displaying user information regarding a user of the mobile terminal; an information delivery server, and an information delivery system.

### BACKGROUND

Recently, a technique for displaying service information provided by an information delivery service provider like a flow (telop-display) in a predetermined direction (for example, from right to left) on a display portion of a mobile terminal has become widespread (see JP 2006-31366 A for example). Here, the service information denotes information provided from an information delivery service provider to users. The service information includes, for example, information on news, information on weather forecast, information on future-telling, information on advertisement of a certain enterprise, traffic information, information on disaster, and the like.

For the purpose of telop-displaying such service information on a display portion of a mobile terminal, the mobile terminal transmits service request information (polling request) to an information delivery server at constant time intervals. The constant time interval is for example one hour or two hours. The information delivery server that receives the service request information accesses to a service information storing portion so as to acquire service information stored in the service information storing portion. In the service information storing portion, service information has been stored in advance by the information delivery service provider. The information delivery server delivers the acquired service information to a mobile terminal that has transmitted the service request information. Thereby, service information is telop-displayed on the display portion of the mobile terminal.

An information processor that retrieves received e-mails agreeing to a preset condition among a plurality of received e-mails and that telop-displays the retrieved received e-mails on the display portion also has been known (see JP H10-269154 A for example).

However, concerning user information recorded in an information apparatus (user information storing portion) possessed by a user at a mobile terminal or user information stored in a server apparatus (user information storing portion), the above-mentioned system has not been established. Here, the user information denotes arbitrary information regarding a user at a mobile terminal. For this reason, when a user at a mobile terminal intends to display user information on a display portion of a mobile terminal, it is required to conduct processes as described below. Namely, the user at the mobile terminal is required to operate the mobile terminal so as to access from the mobile terminal to the user information storing portion thereby acquiring the user information from the user information storing portion. In this manner, user information is displayed on the displays portion of the mobile terminal. Namely, for displaying the user information on the display portion of the mobile terminal, the user at the mobile terminal is required to operate the mobile terminal. It takes labor and time for the user at the mobile terminal.

In a case of displaying service information provided by an information delivery service provider on the display portion of the mobile terminal, the mobile terminal is required to transmit service request information to the information delivery server at constant time intervals. Therefore, in a case where service information is stored newly in the service information storing portion or in a case where service information stored in the service information storing portion is updated, it is impossible to display in real time newly-stored service information or updated service information on the display portion of the mobile terminal.

### SUMMARY

A mobile terminal according to one aspect of the present invention is a mobile terminal that is communicable with an information delivery server that communicates with a user information storing portion that stores user information, whereby acquiring the user information from the user information storing portion and delivering the acquired user information, the mobile terminal comprising: a request type registering portion that accepts request type information indicating a type of user information for which a user at the mobile terminal desires to browse, from the user, and that registers the accepted request type information into a request type recording portion; a notification information receiving portion that, in a case where user information is stored newly in the user information storing portion or user information stored in the user information storing portion is updated, receives, from the user information storing portion, notification information indicating the type of the newly-stored user information or the updated user information; a type collating portion that compares the request type information registered in the request type recording portion and the notification information received by the notification information receiving portion so as to decide whether or not the type of the user information indicated by the request type information and the type of the user information indicated by the notification information coincide with each other; a request information transmitting portion that, in a case where a decision of coincidence is made by the type collating portion, transmits, to the information delivery server, user request information to request delivery of the newly-stored user information or the updated user information to the mobile terminal; an information receiving portion that receives user information delivered from the information delivery server, in accordance with the user request information transmitted by the request information transmitting portion; and a display control portion that displays the user information received by the information receiving portion on a predetermined display area of a display portion provided to the mobile terminal.

The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a block diagram illustrating a schematic configuration of an information delivery system according to an embodiment of the present invention.

FIG. 2 is a block diagram illustrating a schematic configuration of a mobile terminal in the information delivery system.

FIG. 3 is a diagram illustrating an example of request type information recorded in a request type recording portion in the mobile terminal.

FIG. 4 is a diagram illustrating an example of a data structure of user request information generated by a request information control portion in the mobile terminal.

FIG. 5 is a diagram illustrating an example of user information telop-displayed on a predetermined display area of a display portion in the mobile terminal.

FIG. 6 is a block diagram illustrating a schematic configuration of an information delivery server in the information delivery system.

FIG. 7 is a sequence diagram illustrating an example of operations of the mobile terminal.

FIG. 8 is a sequence diagram illustrating an example of operations of the information delivery server in a case where user request information is transmitted from the mobile terminal.

FIG. 9 is a sequence diagram illustrating an example of operations of the information delivery server in a case where service request information is transmitted from the mobile terminal.

### DESCRIPTION OF EMBODIMENTS

In the mobile terminal of the present invention, the request type registering portion accepts, from the user, request type information that indicates the type of user information for which a user at a mobile terminal desires browsing, and registers the accepted request type information into a request type information recording portion. In a case where user information is stored newly in the user information storing portion or in a case where user information stored in the user information storing portion is updated, the notification information receiving portion receives, from the user information storing portion, notification information to indicate the type of the newly-stored user information or the updated user information. And the type collating portion compares the registered request type information and the received notification information so as to decide whether or not the type of user information indicated by the request type information and the user information indicated by the notification information coincide with each other. In a case where a decision of coincidence is made, the request information transmitting portion transmits, to the information delivery server, user request information to request delivery of the newly-stored user information or updated user information to the mobile terminal. The information receiving portion receives user information delivered from the information delivery server, in accordance with the transmitted user request information. And the display control portion display user information received by the information receiving portion on a predetermined display area of the display portion provided in the mobile terminal. Namely, in a case where user information is stored newly in the user information storing portion or in a case where user information stored in the user information storing portion is updated, the mobile terminal of the present invention receives notification information from the user information storing portion, and transmits the user request information to the information delivery server, based on the received notification information. Therefore, it is possible to display user information in real time on a predetermined display area of the display portion, without imposing labor and time on the user at the mobile terminal.

For achieving the above-described object, an information delivery server in the present invention is an information delivery server that is communicable with a mobile terminal, a user information storing portion that stores user information and a service information storing portion that stores service information to be provided to a user at the mobile terminal; the information delivery server comprising: a request information receiving portion that receives, from the mobile terminal, user request information to request delivery of the user information to the mobile terminal or service request information to request delivery of the service information to the mobile terminal; a user information acquiring portion that, in a case where user request information is received by the request information receiving portion, acquires the user information indicated by the user request information, from the user information storing portion; a service information acquiring portion that, in a case where the service request information is received by the request information receiving portion, acquires the service information indicated by the service request information, from the service information storing portion; and an information delivering portion that delivers, to the mobile terminal, the user information acquired by the user information acquiring portion or the service information acquired by the service information acquiring portion.

In the information delivery server of the present invention, the request information receiving portion receives, from the mobile terminal, user request information to request delivery of user information to the mobile terminal or service request information to request delivery of service information to the mobile terminal. Here, in a case where user request information is received by the request information receiving portion, the user information acquiring portion acquires, from the user information storing portion, user information indicated by the user request information. In a case where service request information is received by the request information receiving portion, the service information acquiring portion acquires, from the service information storing portion, service information indicated by the service request information. And the information delivering portion delivers, to the mobile terminal, the user information acquired by the user information acquiring portion or the service information acquired by the service information acquiring portion. Thereby, it is possible to display the user information or the service information on the display portion of the mobile terminal.

For achieving the above-described object, an information delivery system in the present invention includes a mobile terminal according to the present invention and an information delivery server according to the present invention.

For achieving the above-described object, an program in the present invention is a program that that causes a computer to execute processes: the computer being communicable with an information delivery server that communicates with a user information storing portion that stores user information, whereby acquiring user information from the user information storing portion and delivering the acquired user information, the program causing the computer to execute: a request type registration process of accepting request type information indicating the type of user information for which a user of the computer desires browsing, from the user, and registering the accepted request type information into a request type recording portion; a notification information reception process of, in a case where user information is stored newly in the user information storing portion or user information stored in the user information storing portion is updated, receiving, from the user information storing portion, notification information to indicate the type of the newly-stored user information or the updated user information; a type collation process of comparing the request type information registered in the request type recording portion and the notification information received by the notification information reception process so as to decide whether or not the type of the user information indicated by the request type information and the type of the user information indicated by the notification information coincide with each other; a request information transmission process of, in a case where a decision of coincidence is made by the type collation process, transmitting, to the information delivery server, user request information to request delivery of the newly-stored user information or the updated user information to the computer; an information reception process of receiving the user information delivered from the information delivery server, in accordance with the user request information transmitted by the request information transmission process; and a display control process of displaying the user information received by the information reception process on a predetermined display area of a display portion provided to the computer.

For achieving the above-described object, a program in the present invention is a program that causes a computer to execute processes, the computer being communicable with a mobile terminal, a user information storing portion that stores user information, and a service information storing portion that stores service information to be provided to a user at the mobile terminal, the program causing the computer to execute: a request information reception process of receiving, from the mobile terminal, user request information to request delivery of the user information to the mobile terminal or service request information to request delivery of the service information to the mobile terminal; a user information acquisition process of, in a case where the user request information is received by the request information reception process, acquiring, from the user information storing portion, the user information indicated by the user request information; a service information acquisition process of, in a case where the service request information is received by the request information reception process, acquiring, from the service information storing portion, the service information indicated by the service request information; and an information delivery process of delivering, to the mobile terminal, the user information acquired by the user information acquisition process or the service information acquired by the service information acquisition process.

For achieving the above-described object, a method of the present invention is a method for a computer to execute processes, the computer being communicable with an information delivery server that communicates with a user information storing portion that stores user information, whereby acquiring user information from the user information storing portion and delivering the acquired user information, the method comprising: request type registration in which a request type registering portion provided to the computer accepts request type information indicating the type of user information for which a user of the computer desires browsing, from the user, and registers the accepted request type information into the request type recording portion; notification information reception in which, in a case where user information is stored newly in the user information storing portion or user information stored in the user information storing portion is updated, a notification information receiving portion provided to the computer receives, from the user information storing portion, notification information to indicate the type of the newly-stored user information or the updated user information; type collation in which a type collating portion provided to the computer compares the request type information registered in the request type recording portion and the notification information acquired by the notification information acquisition so as to decide whether or not the type of the user information indicated by the request type information and the type of the user information indicated by the notification information coincide with each other; request information transmission in which, in a case where a decision of coincidence is made by the type collation, a request information transmitting portion provided to the computer transmits, to the information delivery server, user request information to request delivery of the newly-stored user information or the updated information to the computer; information reception in which the information receiving portion provided to the computer receives the user information delivered from the information delivery server, in accordance with the user request information transmitted by the request information transmission; and display control in which a display control portion provided to the computer displays user information received by the information reception on a predetermined display area of a display portion provided to the computer.

For achieving the above-described object, a method of the present invention is a method for a computer to execute processes, the computer being communicable with a mobile terminal, a user information storing portion that stores user information, and a service information storing portion that stores service information to be provided to a user at the mobile terminal, the method comprises: request information reception in which a request information receiving portion provided to the computer receives, from the mobile terminal, user request information to request delivery of the user information to the mobile terminal or service request information to request delivery of the service information to the mobile terminal; user information acquisition in which, in a case where the user request information is received by the request information reception, a user information acquiring portion provided to the computer acquires, from the user information storing portion, the user information indicated by the user request information; service information acquisition in which, in a case where the service request information is received by the request information reception, a service information acquiring portion provided to the computer acquires, from the service information storing portion, service information indicated by the service request information; and information delivery in which an information delivering portion provided to the computer delivers, to the mobile terminal, the user information acquired by the user information acquisition or the service information acquired by the service information acquisition.

In an embodiment of the present invention, it is preferable that the information delivery server is communicable with a service information storing portion that stores service information to be provided to the user at the mobile terminal; the request information transmitting portion transmits, to the information delivery server at constant time intervals, service request information to request delivery of the service information to the mobile terminal; the information receiving portion receives service information delivered from the information delivery server, in accordance with the service request information transmitted by the request information transmitting portion; the display control portion is capable of displaying the service information received by the information receiving portion, on the same display area as a predetermined display area for displaying the user information; and the mobile terminal further includes a request information control portion that, in a case where a decision of coincidence is made by the type collating portion, controls to halt transmission of service request information by the request information transmitting portion.

According to the above-described configuration, in a case where a decision of coincidence is made by the type collating portion, the request information control portion controls to halt transmission of the service request information by the request information transmitting portion. Thereby, the display control portion can display user information instead of displaying service information on the predetermined display area of the display portion.

In the embodiment of the present invention, it is preferable that the display control portion is configured to telop-display the user information on the predetermined display area of the display portion.

According to the above-described configuration, since the display control portion telop-displays user information on the predetermined display area, massive user information can be displayed even on a small display area. Here, telop-display denotes displaying like a flow in a predetermined direction.

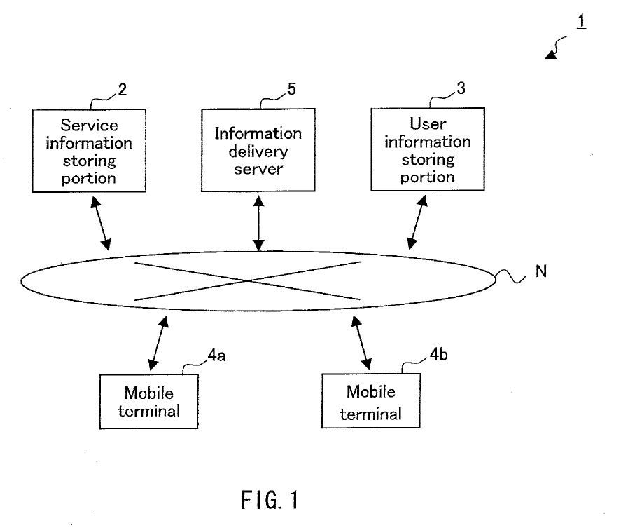

Hereinafter, a further specific embodiment of the present invention will be described in detail with reference to FIG. 1 to FIG. 9.

FIG. 1 is a block diagram illustrating a schematic configuration of an information delivery system 1 according to the present embodiment. Namely, the information delivery system 1 according to the present embodiment includes a service information storing portion 2, a user information storing portion 3, mobile terminals 4a, 4b, and an information delivery server 5. The service information storing portion 2, the user information storing portion 3, the mobile terminals 4a, 4b, and the information delivery server 5 are connected to a communication line N. Examples of the communication line N include Internet, Ethernet (registered trademark), a wireless LAN, any arbitrary computer network, and the like.

In FIG. 1, each one unit of the service information storing portion 2, the user information storing portion 3, and the information delivery server 5 and two mobile terminals 4a, 4b are illustrated for facilitating explanation. It should be noted however, that the number of the service information storing portions 2, the user information storing portions 3, the mobile terminals 4a, 4b, and the information delivery servers 5 as the components of the information delivery system 1 can be determined arbitrarily. It is also possible that a wireless base station (Node-B), a radio network controller (RNC), various client devices, and various servers (Web server, e-mail server, homepage server, proxi server, DNS server, DHCP server and the like) may be present on the information delivery system 1.

Into the service information storing portion 2, service information provided by an information delivery service provider is stored. Here, the service information denotes information to be provided by the information delivery service provider to users. The service information includes, for example, information on news, information on weather forecast, information on future-telling, information on advertisement of a certain enterprise, traffic information, information on disaster, and the like. Namely, the service information denotes a content representing these informations. The information delivery service provider is an entity that provides wireless communication services such as portable phones, for example. The service information to be stored in the service information storing portion 2 has been stored in advance by the information delivery service provider. The service information to be stored in the service information storing portion 2 is updated at regular time intervals by the information delivery service provider.

The user information storing portion 3 is either information equipment (for example, a personal computer, or communication equipment) possessed by the users at the mobile terminals 4a and 4b, or a server apparatus in which user information has been stored. Here, in the user information storing portion 3, arbitrary user information referring to the users at the mobile terminals 4a, 4b is stored. In a case where the user information storing portion 3 is information equipment possessed by the users at the mobile terminals 4a, 4b, the user information is for example schedule information indicating the content of user's schedule or e-mail information indicating the content of the received e-mails of the users. In a case where the user information storing portion 3 is a server apparatus functioning as a phone-answering machine server, the user information is message information indicating the message content stored in the phone-answering machine of the server apparatus. Here it is defined in the present embodiment that the user information storing portion 3 is a server apparatus functioning as a phone-answering machine server, and that the user information is message information indicating the message content stored in the phone-answering machine of the server apparatus. Therefore, the user information stored in the user information storing portion 3 according to the present embodiment makes data of WAVE format as an audio format.

The following explanation in the present embodiment refers to an example where the user at the mobile terminal 4b transmits to the mobile terminal 4a by using the mobile terminal 4b, where since the user at the mobile terminal 4a cannot respond to the received message due to some reasons, the mobile terminal 4b is connected to the user information storing portion 3 that functions as a phone-answering machine. In such a case, message information indicating the message content from the user at the mobile terminal 4b to the user at the mobile terminal 4a is stored newly in the user information storing portion 3.

Here, the user information storing portion 3 has a function of, in a case where user information is stored newly in the user information storing portion 3 or in a case where user information stored in the user information storing portion 3 is updated, transmitting, to the mobile terminals 4a, 4b via the communication line N, notification information to indicate the type of the newly-stored user information or the updated user information. Namely, the user information storing portion 3 has a function of storing user information and transmitting notification information to the mobile terminals 4a, 4b (notification function). For this purpose, terminal IDs indicating the addresses of the mobile terminals 4a, 4b are recorded in the user information storing portion 3. Here, the type of the user information denotes a type to classify the user information in accordance with a certain category. In the present embodiment, since message information indicating a message content from the user at the mobile terminal 4b to the user at the mobile terminal 4a is stored newly in the user information storing portion 3, the user information storing portion 3 transmits notification information indicating that the user information is message information, to the mobile terminal 4a via the communication line N. In the present embodiment, the notification information indicating that the user information is message information is represented as “200”.

In the present embodiment, there is no particular limitation on the time for transmission from either the point at which user information is stored newly or at which the user information is updated to the point at which notification information is transmitted to the mobile terminals 4a, 4b. However, this time for transmission is preferred to be shorter for displaying the user information in real time on the display portion 49.

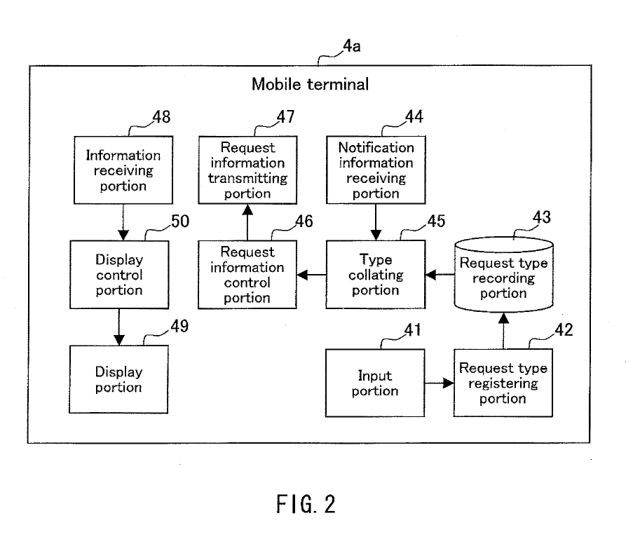

FIG. 2 is a block diagram illustrating a schematic configuration of the mobile terminal 4a according to the present embodiment. The configuration of the mobile terminal 4b is common to the configuration of the mobile terminal 4a as illustrated in FIG. 2. Namely, the mobile terminal 4a includes an input portion 41, a request type registering portion 42, a request type recording portion 43, a notification information receiving portion 44, a type collating portion 45, a request information control portion 46, a request information transmitting portion 47, an information receiving portion 48, a display portion 49 and a display control portion 50. The mobile terminals 4a, 4b are wireless-communicable terminals such as portable phones, PHS (Personal Handyphone System), PDA (Personal Digital Assistant), HHT (Hand Held Terminal), notebook personal computers, tablet personal computers and the like.

Here, respective functions of the above-described input portion 41, the request type registering portion 42, the notification information receiving portion 44, the type collating portion 45, the request information control portion 46, the request information transmitting portion 47, the information receiving portion 48, the display portion 49 and the display control portion 50 are implemented as a result of executing a predetermined program by the calculator such as CPU provided in a computer. Therefore, a program for implementing each of the above-mentioned functions with computer and also a recording medium that records the program compose one embodiment of the present invention. The request type recording portion 43 is embodied by an internal memory of the computer or a memory accessible from this computer.

The input portion 41 is composed of any arbitrary inputting device such as an input key, an input button, a touch panel and a speech recognizer.

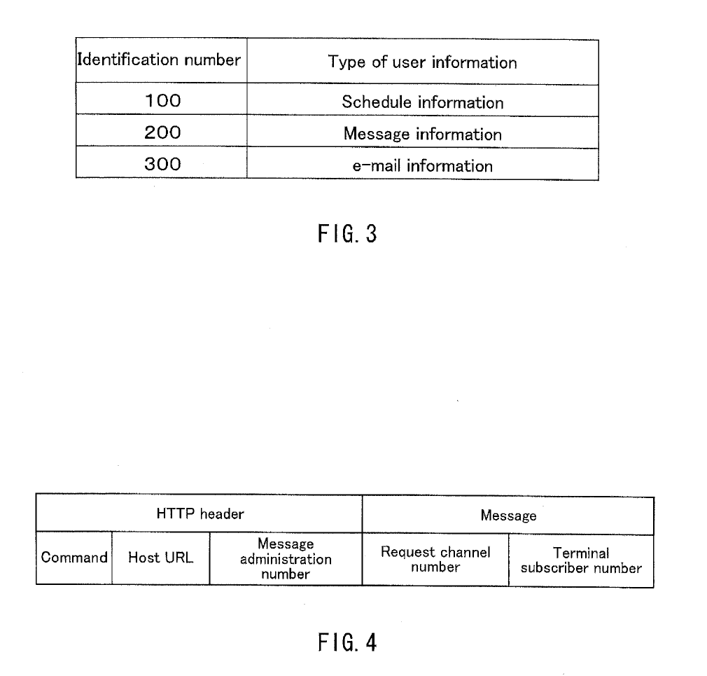

The request type registering portion 42 accepts request type information indicating the type of user information for which the user at the mobile terminal 4a desires browsing, from the user via the input portion 41. The request type registering portion 42 registers the accepted request type information into the request type recording portion 43. FIG. 3 is a diagram illustrating an example of request type information registered in the request type recording portion 43 according to the present embodiment. As illustrated in FIG. 3, in the request type recording portion 43, identification numbers and types of user information are recorded as request type information. Here, the identification number is a number to identify the type of user information to one meaning. In the example illustrated in FIG. 3, as the request type information, an identification number “100” and a type of user information “schedule information” are recorded in the request type recording portion 43. Further, as the request type information, an identification number “200” and a type of user information “message information” are recorded in the request type recording portion 43. Moreover, as request type information, an identification number “300” and a type of user information “e-mail information” are recorded in the request type recording portion 43.

In a case where notification information is transmitted from the user information storing portion 3, the notification information receiving portion 44 receives the notification information transmitted from the user information storing portion 3. The notification information receiving portion 44 outputs the received notification information to the type collating portion 45.

The type collating portion 45 compares the request type information registered in the request type recording portion 43 and the notification information outputted from the notification information receiving portion 44 so as to decide whether or not the type of user information indicated by the request type information and the type of the user information indicated by the notification information coincide with each other. In the present embodiment, since the notification information outputted from the notification information receiving portion 44 represents “200”, the type collating portion 45 decides that the notification information “200” and the identification number “200” indicated by the request type information coincide with each other.

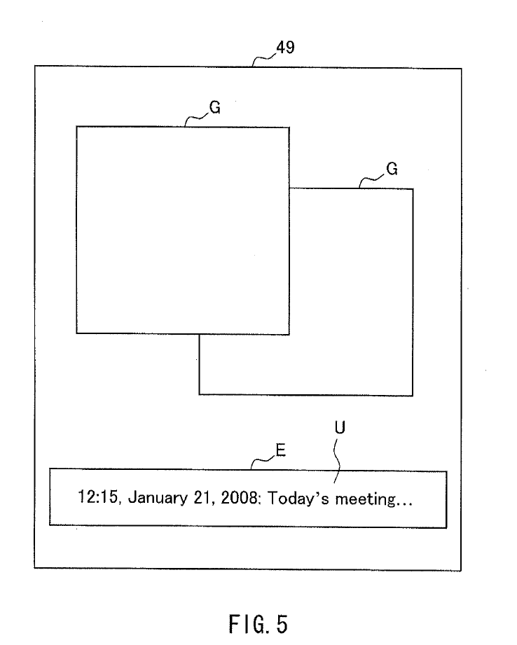

In a case where a decision of coincidence is made by the type collating portion 45, the request information control portion 46 generates user request information (polling information) to request delivery of newly-stored user information or updated user information to the mobile terminal 4a. FIG. 4 is a diagram illustrating an example of a data structure of user request information generated by the request information control portion 46 according to the present embodiment. As illustrated in FIG. 4, the user request information includes a HTTP (Hyper Text Transfer Protocol) header and a message (body). The HTTP header includes a command, a host URL indicating the address of the information delivery server 5, and a message administration number for administering messages. The message includes a request channel number and a terminal subscriber number. In the present embodiment, the identification number “200” to indicate as being message information and address information (IP address, MAC address and the like) to indicate the location of the user information storing portion 3 on the network are assembled into the request channel number. Further, the terminal ID of the mobile terminal 4a as the sender is assembled into the terminal subscriber number. The request information control portion 46 outputs the generated user request information to the request information transmitting portion 47.

The request information control portion 46 has further a function of generating service request information (polling information) to request delivery of service information stored in the service information storing portion 2 to the mobile terminal 4a. Namely, the request information control portion 46 generates service request information at constant time intervals. The constant time interval is one hour or two hours, for example. In a case of generating service request information, the request information control portion 46 outputs the generated service request information to the request information transmitting portion 47.

Here, in a case where a decision of coincidence is made by the type collating portion 45, the request information control portion 46 according to the present embodiment halts the process of generating service request information conducted at constant time intervals. Thereby, the request information control portion 46 can generate user request information instead of the service request information. In the present embodiment, the user at the mobile terminal 4a can resume the process of generating the halted service request information by conducting a cancellation process via the input portion 41.

In a case where user request information is outputted from the request information control portion 46, the request information transmitting portion 47 transmits the user request information to the information delivery server 5 via the communication line N. Further, in a case where service request information is outputted from the request information control portion 46, the request information transmitting portion 47 transmits the service request information to the information delivery server 5 via the communication line N at constant time intervals.

In a case where user information is delivered from the information delivery server 5 in accordance with user request information transmitted by the request information transmitting portion 47, the information receiving portion 48 receives the user information. The information receiving portion 48 outputs the received user information to the display control portion 50. Further, in a case where service information is delivered from the information delivery server 5 in accordance with the service request information transmitted by the request information transmitting portion 47, the information receiving portion 48 receives the service information. The information receiving portion 48 outputs the received service information to the display control portion 50.

The display portion 49 is composed of any arbitrary display device such as a liquid crystal display, an organic EL display, a plasma display and a CRT display.

In a case where service information is outputted from the information receiving portion 48, the display control portion 50 telop-displays the service information on a predetermined display area of the display portion 49. Here the telop-display denotes displaying like a flow in a predetermined direction. In a case where user information is outputted from the information receiving portion 48, the display control portion 50 telop-displays the user information on the same display area as the display area for telop-displaying the service information. Thereby, in comparison with an embodiment where a display area for telop-displaying service information and a display area for telop-displaying user information are different from each other, the display area of the display portion 49 to display either user information or service information can be reduced. Further, since the display control portion 50 telop-displays user information on the display area, massive user information can be displayed even on a small display area.

FIG. 5 is a diagram illustrating an example of user information telop-displayed on a display area of the display portion 49 according to the present embodiment. As illustrated in FIG. 5, a display area E is formed on the bottom part of the display portion 49. It should be noted that the location of the display area E is not limited particularly. In the display area E, user information U is displayed so that characters will flow from right to left. The user information U is for example a message content converted to a text format. In the display portion 49, an arbitrary image G is displayed in addition to the user information U. In the present embodiment, on the display area E of the display portion 49, the telephone number of the mobile terminal 4b as the sender and also the date and hour at which message information is stored newly into the user information storing portion 3 (storage date and hour) are telop-displayed together with the user information U. Thereby, the user at the mobile terminal 4a can browse the message content from the user at the mobile terminal 4b, and can browse also the telephone number of the mobile terminal 4b and the date and hour of storage.

In the above-described example, though the display control portion 50 telop-displays the user information U on the display area E of the display portion 49, but the present invention is not limited to this example. The display control portion 50 may display simply the user information U on the display area E of the display portion 49, for example. In this case, for example, instead of a flowing display like a telop display, the user information U may be divided into units of information amount that can be displayed on the display area E and displayed with a switchover at a predetermined time period. Alternatively, only a predetermined part of the user information may be displayed.

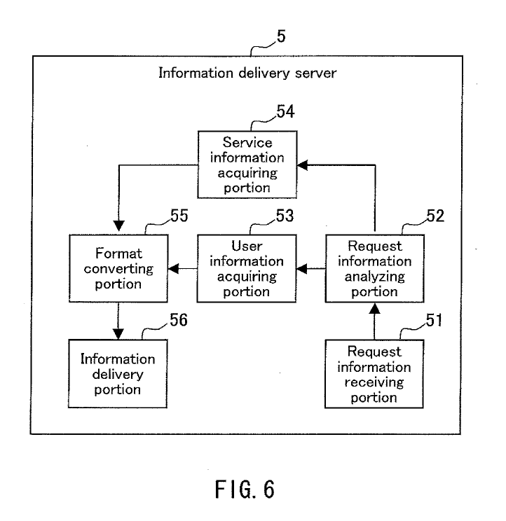

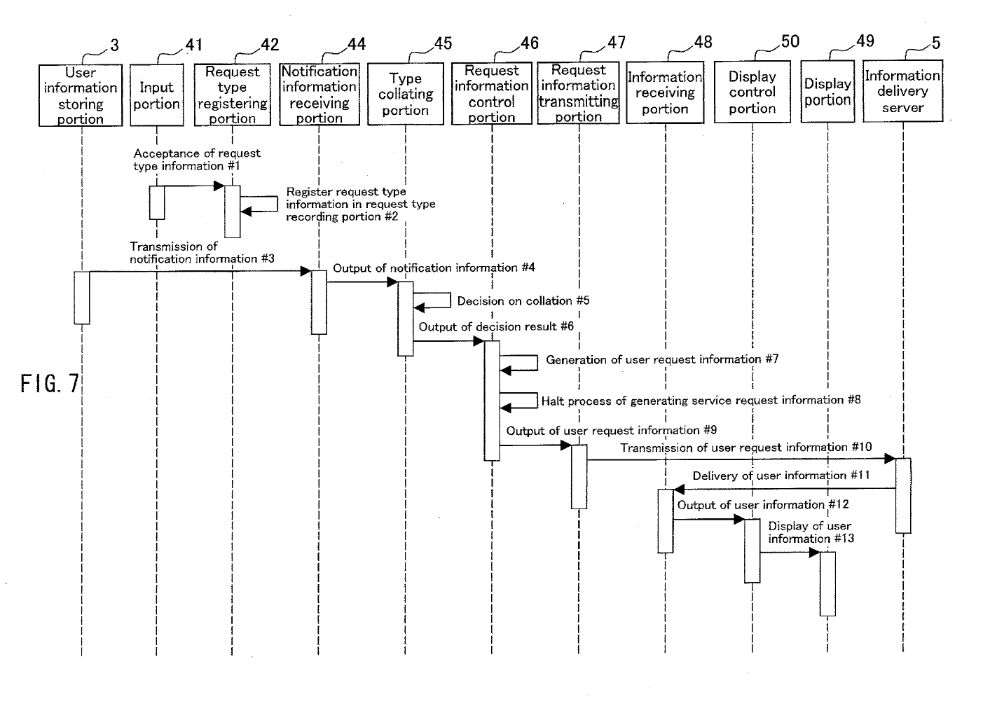

FIG. 6 is a block diagram illustrating a schematic configuration of the information delivery server 5 according to the present embodiment. Namely, the information delivery server 5 includes a request information receiving portion 51, a request information analyzing portion 52, a user information acquiring portion 53, a service information acquiring portion 54, a format converting portion 55 and an information delivering portion 56.

The respective functions of the above-described request information receiving portion 51, the request information analyzing portion 52, the user information acquiring portion 53, the service information acquiring portion 54, the format converting portion 55 and the information delivering portion 56 are implemented by execution of a predetermined program by a calculator such as CPU provided in the computer. Therefore, a program for implementing the respective functions with a computer or a recording medium on which the same are recorded also compose one embodiment of the present invention.

In a case where service request information is transmitted from the mobile terminal 4a, the request information receiving portion 51 receives the service request information. The request information receiving portion 51 outputs the received service request information to the request information analyzing portion 52. Further, in a case where user request information is transmitted from the mobile terminal 4a, the request information receiving portion 51 receives the user request information. The request information receiving portion 51 outputs the received user request information to the request information analyzing portion 52.

The request information analyzing portion 52 analyzes either the service request information or the user request information outputted from the request information receiving portion 51. For example, in a case where the request information outputted from the request information receiving portion 51 is user request information, the request information analyzing portion 52 extracts a request channel number from the user request information. Based on the extracted request channel number, the request information analyzing portion 52 detects address information of the user information storing portion 3 in which the user information to be acquired is stored. By outputting the detected address information, the request information analyzing portion 52 issues an instruction to the user information acquiring portion 53 so as to acquire user information indicated by the user request information from the user information storing portion 3. Alternatively for example, in a case where the request information outputted from the request information receiving portion 51 is service request information, the request information analyzing portion 52 reads out address information of the service information storing portion 2 that has been recorded on a memory (not illustrated) in the information delivery server 5, from the memory. The request information analyzing portion 52 outputs the readout address information, thereby issues an instruction to the service information acquiring portion 54 so as to acquire service information indicated by the service request information from the service information storing portion 2.

The user information acquiring portion 53 acquires user information indicated by the user request information, from the user information storing portion 3 via the communication line N, in accordance with the instruction from the request information analyzing portion 52. The user information acquiring portion 53 outputs the acquired user information to the format converting portion 55.

The service information acquiring portion 54 acquires service information indicated by the service request information, from the service information storing portion 2 via the communication line N, in accordance with the instruction from the request information analyzing portion 52. The service information acquiring portion 54 outputs the acquired service information to the format converting portion 55.

The format converting portion 55 converts the format of user information outputted from the user information acquiring portion 53 or the format of service information outputted from the service information acquiring portion 54 to a format that can be displayed on the display portion 49 of the mobile terminal 4a. In the present embodiment, since the user information outputted from the user information acquiring portion 53 is WAVE format, the format converting portion 55 converts the WAVE format to a text format. The format converting portion 55 outputs user information or service information with converted format to the information delivering portion 56.

In a case where user information is outputted from the format converting portion 55, the information delivering portion 56 delivers the user information to the mobile terminal 4a via the communication line N. In a case where service information is outputted from the format converting portion 55, the information delivering portion 56 delivers the service information to the mobile terminal 4a via the communication line N.

Next, operations of the information delivery system 1 having the above-described configuration will be explained below with reference to FIGS. 7-9.

FIG. 7 is a sequence diagram illustrating an example of operations of the above-described mobile terminal 4a. Namely, as illustrated in FIG. 7, the request type registering portion 42 accepts request type information indicating the type of user information for which a user at the mobile terminal 2a desires browsing, from the user via the input portion 41 (#1). The request type registering portion 42 registers the request type information accepted in #1, into the request type registering portion 43 (#2).

The notification information receiving portion 44 receives notification information transmitted from the user information storing portion 3 (#3). The notification information receiving portion 44 outputs the notification information acquired in #3 to the type collating portion 45 (#4). The type collating portion 45 compares the request type information registered in #2 and the notification information outputted in #4 so as to decide whether or not the type of user information indicated by the request type information and the type of user information indicated by the notification information coincide with each other (#5). The type collating portion 45 outputs the decision result in #5 to the request information control portion 46 (#6).

And, if the decision result outputted in #6 indicates that the type of user information indicated by the request type information and the type of user information indicated by the notification information coincide with each other, the request information control portion 46 generates user request information to request delivery of the newly-stored user information or the updated user information to the mobile terminal 4a (#7). And the request information control portion 46 halts the process of generating service request information which is conducted at constant time intervals (#8). The request information control portion 46 outputs user request information generated in #7 to the request information transmitting portion 47 (#9). The request information transmitting portion 47 transmits the user request information outputted in #9 to the information delivery server 5 via the communication line N (#10).

And in accordance with the user request information transmitted in #10, the information receiving portion 48 receives user information delivered from the information delivery server 5 (#11). The information receiving portion 48 outputs the user information received in #11 to the display control portion 50 (#12). The display control portion 50 telop-displays the user information outputted in #12 on the display area E of the display portion 49 (#13). Thereby, the user information U is telop-displayed like a flow from the right to the left on the display area E of the display portion 49 as illustrated in FIG. 5. As a result, the user at the mobile terminal 4a can browse the user information U.

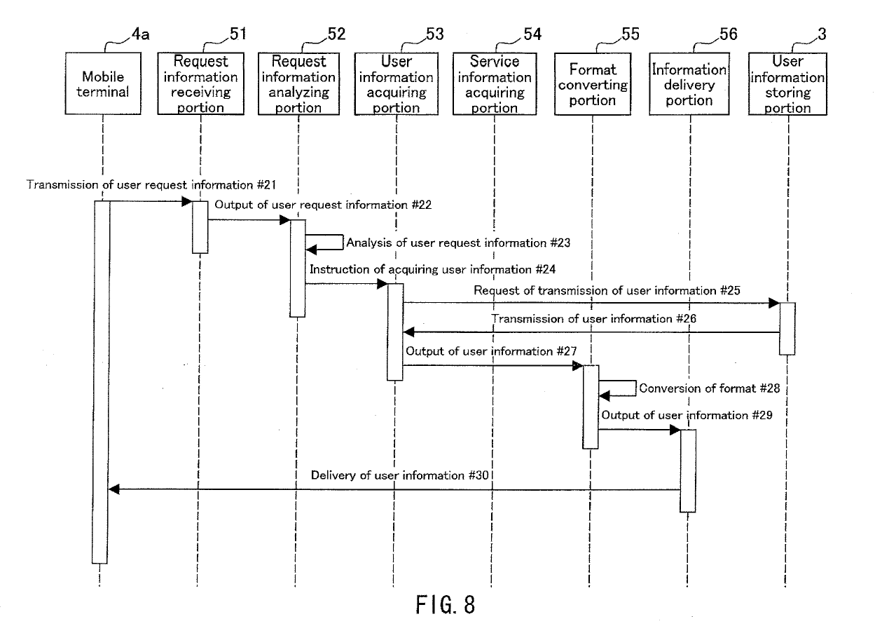

FIG. 8 is a sequence diagram illustrating an example of operations of the above-described information delivery server 5 in a case where user request information is transmitted from the mobile terminal 4a. Namely, as illustrated in FIG. 8, the request information receiving portion 51 receives user request information transmitted (#10 in FIG. 7) from the mobile terminal 4a (#21). The request information receiving portion 51 outputs the user request information received in #21 to the request information analyzing portion 52 (#22).

And the request information analyzing portion 52 analyzes the user request information outputted in #22 (#23). After the analysis in #23, the request information analyzing portion 52 issues an instruction to the user information acquiring portion 53 so as to acquire user information indicated by the user request information outputted in #22, from the user information storing portion 3 (#24). In accordance with the instruction in #24, the user information acquiring portion 53 makes a request to the user information storing portion 3 so as to transmit user information indicated by the user request information to the information delivery server 5 (#25). In accordance with the transmission request in #25, the user information storing portion 3 transmits the user information indicated by the user request information to the information delivery server 5 (user information acquiring portion 53) (#26). Thereby, the user information acquiring portion 53 can acquire the user information. The user information acquiring portion 53 outputs the acquired user information to the format converting portion 55 (#27).

And the format converting portion 55 converts the format of the user information outputted in #27 to a format displayable on the display portion 49 of the mobile terminal 4a (#28). The format converting portion 55 outputs the user information with a format converted in #28 to the information delivering portion 56 (#29). The information delivering portion 56 delivers the user information outputted in #29 to the mobile terminal 4a via the communication line N (#30).

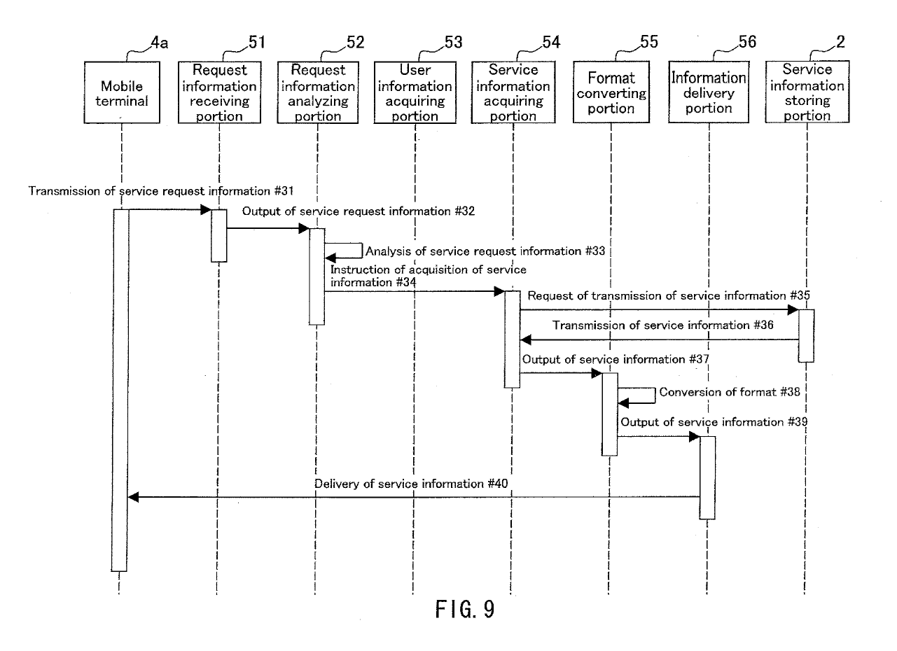

FIG. 9 is a sequence diagram illustrating an example of operations of the above-described information delivery server 5 in a case where service request information is transmitted from the mobile terminal 4a. Namely, as illustrated in FIG. 9, the request information receiving portion 51 receives the service request information transmitted from the mobile terminal 4a (#31). The request information receiving portion 51 outputs the service request information received in #31 to the request information analyzing portion 52 (#32).

And the request information analyzing portion 52 analyzes the service request information outputted in #22 (#33). After the analysis in #33, the request information analyzing portion 52 issues an instruction to the service information acquiring portion 54 so as to acquire service information indicated by the service request information outputted in #32, from the service information server 2 (#34). In accordance with the instruction in #34, the service information acquiring portion 54 makes a request to the service information storing portion 2 so as to transmit the service information indicated by the service request information to the information delivery server 5 (#35). In accordance with the transmission request in #35, the service information storing portion 2 transmits the service information indicated by the service request information to the information delivery server 5 (service information acquiring portion 54) (#36). Thereby, the service information acquiring portion 54 can acquire the service information. The service information acquiring portion 54 outputs the acquired service information to the format converting portion 55 (#37).

And the format converting portion 55 converts the format of the service information outputted in #37 to a format displayable on the display portion 49 of the mobile terminal 4a (#38). The format converting portion 55 outputs the service information with a format converted in #38 to the information delivering portion 56 (#39). The information delivering portion 56 delivers the service information outputted in #39 to the mobile terminal 4a via the communication line N (#40).

As described above, in the information delivery system 1 according to the present embodiment, in a case where user information is stored newly in the user information storing portion 3 or in a case where user information stored in the user information storing portion 3 is updated, the newly-stored user information or the updated user information can be displayed in real time on the display portion 49 of the mobile terminal 4a without imposing labor and time on the user at the mobile terminal 4a. Moreover, since variations of information whose delivery is desired by the user utilizing the information delivery system 1 can be added easily, convenience of the information delivery service is improved.

The explanation of the present embodiment refers to an example where the user information storing portion is a server apparatus that functions as a telephone answering machine and the user information is message information indicating a message content stored in the telephone answering machine of the server apparatus, but the present invention is not limited to this example. Alternatively for example, the user information storing portion may be information equipment possessed by a user at a mobile terminal, and the user information may be schedule information indicating a content of the user's schedule recorded in the information equipment. Further for example, the user information storing portion may be information equipment possessed by a user at a mobile terminal, and the user information may be e-mail information indicating the content of user's received e-mail recorded in the information equipment. Namely, if the user information is information concerning a user at a mobile terminal, various arbitrary informations can be included other than the above-described message information, schedule information and e-mail information, as long as update and addition occur at irregular/regular time intervals and the user acquires appropriately the information to make reference thereof.

Namely, the present invention is not limited to the above-described embodiment but can be modified variably within the range as indicated in the claims. In other words, the technical scope of the present invention includes also the embodiment obtained by combining technical means appropriately modified within the range as indicated in the claims.

As mentioned above, the present invention is used favorably for a mobile terminal, an information delivery server or an information delivery system that enable to display user information in real time on a display portion of the mobile terminal without imposing labor and time on the user at the mobile terminal.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

1. A mobile terminal that is communicable with an information delivery server that communicates with a user information storing portion that stores user information, whereby acquiring the user information from the user information storing portion and delivering the acquired user information, the mobile terminal comprising:
a request type registering portion that accepts request type information indicating a type of user information for which a user at the mobile terminal desires to browse, from the user, and that registers the accepted request type information into a request type recording portion;
a notification information receiving portion that, in a case where user information is stored newly in the user information storing portion or in a case where user information stored in the user information storing portion is updated, receives, from the user information storing portion, notification information indicating the type of the newly-stored user information or the updated user information;
a type collating portion that compares the request type information registered in the request type recording portion and the notification information received by the notification information receiving portion so as to decide whether or not the type of the user information indicated by the request type information and the type of the user information indicated by the notification information coincide with each other;
a request information transmitting portion that, in a case where a decision of coincidence is made by the type collating portion, transmits, to the information delivery server, user request information to request delivery of the newly-stored user information or the updated user information to the mobile terminal;
an information receiving portion that receives user information delivered from the information delivery server, in accordance with the user request information transmitted by the request information transmitting portion; and
a display control portion that displays the user information received by the information receiving portion on a predetermined display area of a display portion provided to the mobile terminal.

2. The mobile terminal according to claim 1, wherein the information delivery server is communicable with a service information storing portion that stores service information to be provided to the user at the mobile terminal;
the request information transmitting portion transmits, to the information delivery server at constant time intervals, service request information to request delivery of the service information to the mobile terminal;
the information receiving portion receives the service information delivered from the information delivery server, in accordance with the service request information transmitted by the request information transmitting portion;
the display control portion is capable of displaying the service information received by the information receiving portion, on the same display area as the predetermined display area for displaying the user information; and
the mobile terminal further comprises a request information control portion that controls to halt transmission of the service request information by the request information transmitting portion in a case where a decision of coincidence is made by the type collating portion.

3. The mobile terminal according to claim 1, wherein the display control portion displays the user information as a telop on the predetermined display area of the display portion.

4. A method for a computer to execute processes, the computer being communicable with an information delivery server that communicates with a user information storing portion that stores user information, whereby acquiring user information from the user information storing portion and delivering the acquired user information, the method comprising:
request type registration in which a request type registering portion provided to the computer accepts request type information indicating the type of user information for which a user of the computer desires browsing, from the user, and registers the accepted request type information into the request type recording portion;
notification information reception in which, in a case where user information is stored newly in the user information storing portion or in a case where user information stored in the user information storing portion is updated, a notification information receiving portion provided to the computer receives, from the user information storing portion, notification information to indicate the type of the newly-stored user information or the updated user information;
type collation in which a type collating portion provided to the computer compares the request type information registered in the request type recording portion and the notification information acquired by the notification information acquisition so as to decide whether or not the type of the user information indicated by the request type information and the type of the user information indicated by the notification information coincide with each other;
request information transmission in which, in a case where a decision of coincidence is made by the type collation, a request information transmitting portion provided to the computer transmits, to the information delivery server, user request information to request delivery of the newly-stored user information or the updated information to the computer;
information reception in which the information receiving portion provided to the computer receives the user information delivered from the information delivery sewer, in accordance with the user request information transmitted by the request information transmission; and
display control in which a display control portion provided to the computer displays user information received by the information reception on a predetermined display area of a display portion provided to the computer.

5. A method for a computer to execute processes, the computer being communicable with a mobile terminal, a user information storing portion that stores user information, and a service information storing portion that stores service information to be provided to a user at the mobile terminal, the method comprises:
request information reception in which a request information receiving portion provided to the computer receives, from the mobile terminal, user request information to request delivery of the user information to the mobile terminal or service request information to request delivery of the service information to the mobile terminal;
user information acquisition in which, in a case where the user request information is received by the request information reception, a user information acquiring portion provided to the computer acquires, from the user information storing portion, the user information indicated by the user request information;
service information acquisition in which, in a case where the service request information is received by the request information reception, a service information acquiring portion provided to the computer acquires, from the service information storing portion, service information indicated by the service request information; and
information delivery in which an information delivering portion provided to the computer delivers, to the mobile terminal, the user information acquired by the user information acquisition or the service information acquired by the service information acquisition.
